(19) United States
(12) Patent Application Publication
(10) Pub. No.: US 2006/0011313 A1
(43) Pub. Date: Jan. 19, 2006

(54) Auto shade and heat

(76) Inventor: Otis G. Wilson, Eastover, SC (US)

Correspondence Address: OTIS G. WILSON, 1132 RICHARD SIMONS RD., EASTOVER, SC, 29044, US

(21) Appl. No.: 10/884,656

(22) Filed: Jul. 3, 2004

(51) Int. Cl. B60J 1/20

(52) U.S. Cl. 160/370.22

(57) ABSTRACT

The auto shade and heat invention (12) will allow the user to manipulate the outdoor temperature in a specified area. The user will be able to expand a ventilated tarp (17) with a hand crank (18) in an upward position away from sun to either reduce temperature or increase temperature in predetermined square foot perimeter thus allowing for a more desirable condition outside residence for the user. This will allow the user to enjoy a more comfortable atmosphere outside the perimeter surrounding the household.

### BACKGROUND

This invention can be associated with tree shade and the warmth given off by the sun, providing cool conditions in hot temperatures and warm conditions in cold temperatures, in a specified outdoor perimeter. Outdoors temperatures are not always suitable for an individual around his or her residence. The auto shade and heat apparatus can allow the user to manipulate the temperatures to a more desirable condition in a safe manner.

For example in hot temperatures outside the household, where the user has positioned the auto shade and heat invention, the user can expand the dark, colored ventilated tarp in an upward angle away from the sun, to cover a predetermined area to reduce the temperature in a square foot perimeter. And in cold temperatures outside the household, where the user has positioned the auto shade and heat apparatus, the user can expand the ventilated magnifying tarp, which is Plexiglas made into small magnifying heat lenses woven together, in an upward angle away from the sun to cover a predetermined area to increase the temperature in a square foot perimeter.

The invention derives from human desire for comfortable, outdoor temperatures. During an individual lifetime, he or she will most likely, depending on the geographical region, have some discomfort from temperatures outside the household, resulting from climate or seasonal change. The auto shade and heat invention will help minimize this discomfort of unwanted outdoor temperature to some degree!

### SUMMARY

This invention, auto shade and heat apparatus, can produce shade and heat similar to that of a large oak tree and the warmth given off by the summer sun. This invention will allow the user to minimize the discomfort of undesired outdoor household temperatures. This apparatus will be placed in a predetermined area. When the ventilated tarp is expanded from its' bottom position to its' top position, either by the crank handle or electrical motor system, the application will provide a certain amount of manipulation of the cold temperature or hot temperature depending on which tarp is used. The ventilated, magnifying, Plexiglas tarp will be used to increase cold temperatures. The ventilated, dark colored tarp will be used decrease temperatures!

### DRAWING

FIG. 1 is perspective left-side view of the auto shade and heat invention, showing the top left-side and the bottom left-side.

FIG. 2 is a perspective front view of the auto shade and heat invention left durable column.

FIG. 3 is perspective front view of the auto shade and heat invention right durable column.

FIG. 4 is perspective auto view of the auto shade and heat invention slotted side of the right side of the durable column.

FIG. 5 is a perspective view of the shade and heat invention slotted side of the left side of the durable column.

FIG. 6 is a perspective view of the auto shade and heat invention internal side view of the guide tracks which represents the internal view of both the left and right guide tracks. Also a view of the top gear and bottom gear is shown.

FIG. 7 is a perspective left-side view of the auto shade and heat invention which also exposes internal view of gear system engaged.

### DETAIL DESCRIPTION

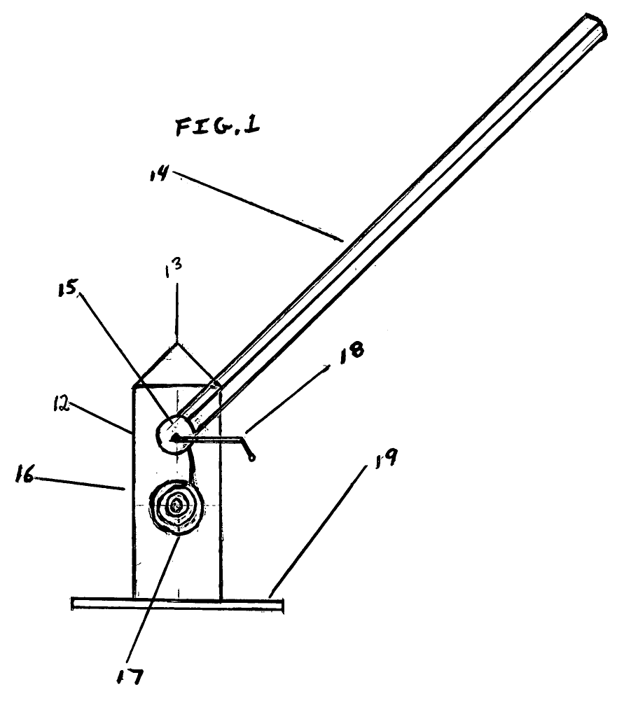

FIG. 1 is a perspective view of the left-side of the auto shade and heat invention 12. The top section of the durable column has a cap 13. The durable columns, which will consist of 2 per. Unit, support the galvanized guide track 14 which will consist of two per. Unit. The gear box 15 houses the gear system the hand-crank 18 operated the gear system the roll of ventilated tarp 17 is supported by two durable columns 16. And the base plates 19 stabilizes and supports the durable columns 16.

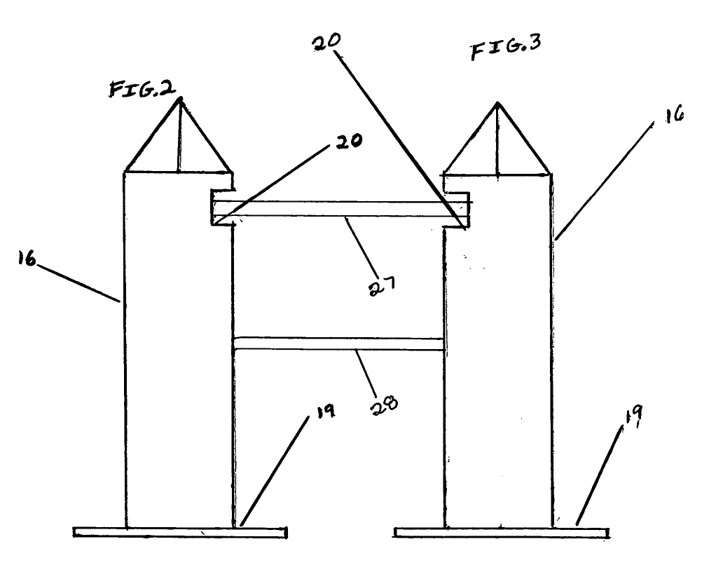

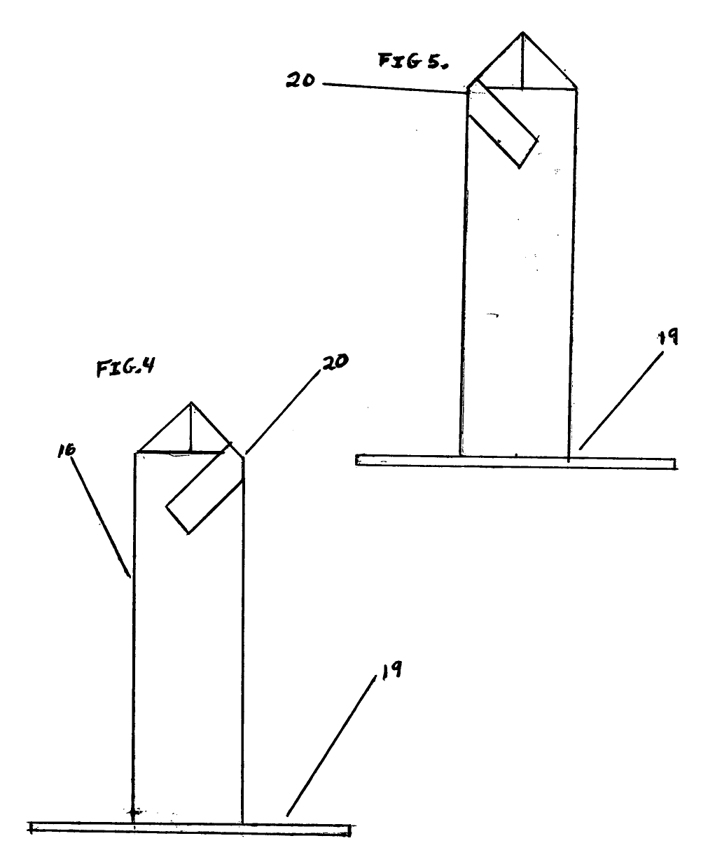

FIG. 2 is a front perspective view of the invention, showing the slotted location 20 for the left guide track 14. The gear rod 27 extends from left durable column to the right durable column (FIG. 3). The front view of the durable column 16 is shown. Below the gear rod 27, the coiled rod 28 for the ventilated tarp 17 extends from left durable column 16 to right durable column 16 (FIG. 3). And front view of the base plate 19 is shown.

FIG. 3 is a front perspective view of the invention showing the slotted location 20 for the right guide track 14. The gear rod 27 extends fro the right durable column to the left durable column (FIG. 2). the front view of the durable column 16 is shown. Below the gear rod 27, the coiled rod 28 for ventilated tarp 17 extends from the right durable column 16 to the left durable column 16 (FIG. 2). And the front view of the base plate 19 is shown.

FIG. 4 is a perspective view of the left side of the right durable column 16. The view shows slotted location 20 for the guide track 14. The left view of the right base plate 19 for the durable column 16.

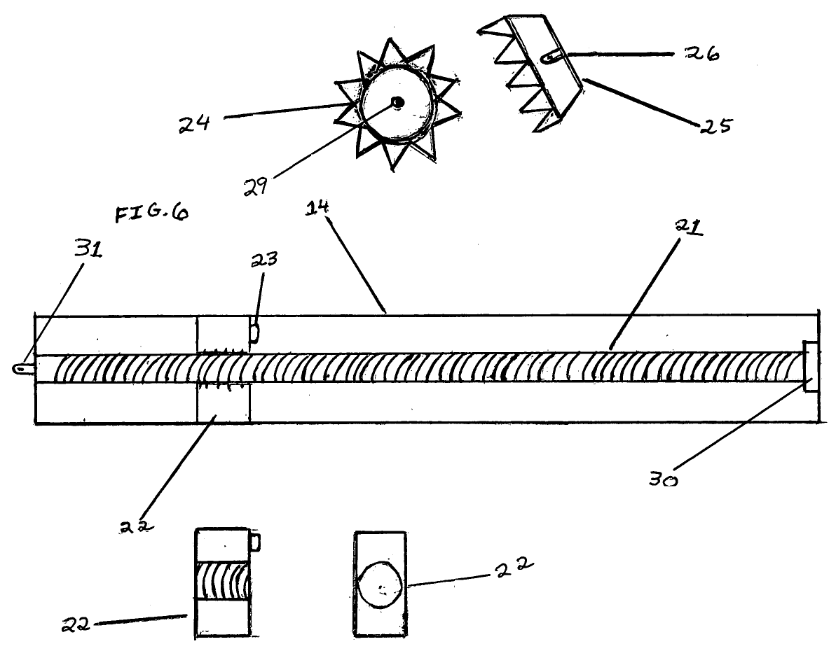

FIG. 5 is perspectives view of the right side of the 16 the left durable column. The view shows 20 the slotted location for the guide track. 19 is left view of the base plate for durable column.

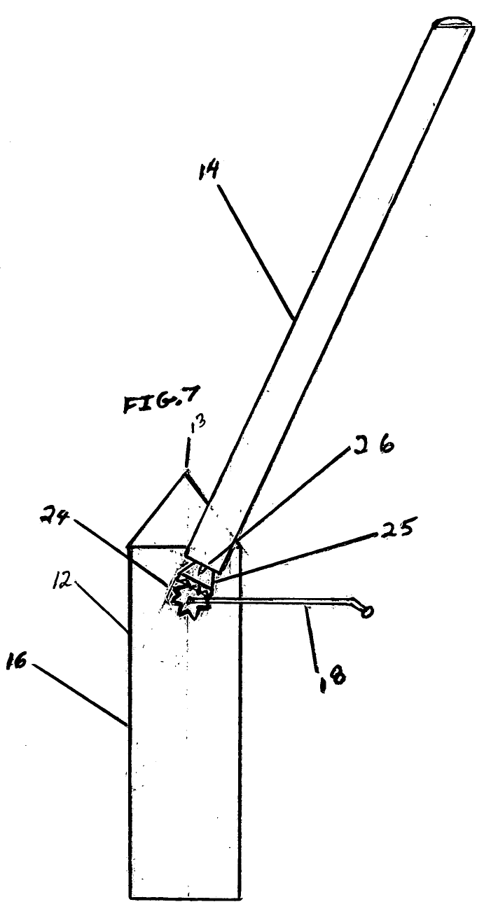

FIG. 6 is internal side view of both left and right guide tracks 14. The open side of the guides tracks 14 faces inward towards ventilated tarp 17. The view of the thread rod 21 is shown, the guide block 22, guide tab 23, the gear pin 31, bottom gear 24, hand crank insert hole 29, top gear 25, insert hole for gear pin 26, and bushing 30 for thread rod.

FIG. 7 is the left side view of auto shade and heat invention 12 with an exposed view of internal bottom gear 24, top gear 25, insert hole for gear pin 26, the insert hole for gear pin 31, guide track 14, crank handle 18, and the durable column 16.

### REFERENCE NUMERALS

12 auto shade and heat invention
13 the cap
14 the guide track
15 the gear box
16 durable column
17 the roll of ventilated tarp (dark colored) and (Plexiglas heat lens)
18 the crank handle
19 the base plate
20 the slotted location
21 the threaded rod
22 the guide block
23 the guide tab
24 the bottom gear
25 the top gear
26 the insert hole for the gear pin
27 the gear rod
28 the coil rod for ventilated tarp
29 the hand crank insert hole
30 the bushing for thread rod
31 the gear pin

### OPERATION

In operating the auto shade and heat invention 12, the user must evaluate the weather conditions before operating. If weather conditions, such as high winds and severe thunder storms exist, the auto shade and heat invention 12, should not be used. If weather conditions are favorable, such as sunny, no precipitation, and no high winds or cold, no precipitation, and no high winds, the user can operate the invention.
(1) The user must check the roll of ventilated tarp 17 for any debris on top and around the circumference of the roll. If there is any debris it must be removed!
(2) The user must remove caps 13 on top of durable columns 16 to inspect top gear 25 and bottom gear 24 for debris and proper lubrication. If there is any debris, it must be removed. If gears lack lubrication they must be lubricated.
(3) The guide tracks 14 must be checked for debris. If there is any debris it must be removed.
(4) The threaded rods 21 must be checked for any debris and proper lubrication. If there is any debris, it must be removed. If the threaded rods 21 lack lubrication, they must be lubricated.
(5) The crank handle 18 must be inserted in the handle crank insert hole 29.
(6) The crank handle must be turned clockwise in order to move the left and right guide block 22 from bottom to top along the threaded rods 21. The ventilated tarp 17 will expand from the bottom of guide tracks 14 to the top of guide track 14 in an upward angle away from the sun.
(7) In order to roll the ventilated tarp 17 back down the crank handle must be turn counter clockwise. This descends the tarp back down the guide tracks 14 to the start position.

1. The Auto Shade and Heat invention:
an apparatus that has two durable columns with two guide tracks connected, one track connected to the right durable column, and the other track connect to the left durable column angling upward and away from the sun, with a ventilated tarp connected to the bottom of the guide tracks, one side of the tarp connected to the left guide track and the other side of the tarp connected to the right guide track, with thread rods connected to the gear system controlled by either by crank the handle or remote electrical motor, which allows the user to turn crank handle in clockwise motion or in counter clockwise motion, in order to extend tarp in upward angle or descend in downward angle, away from the sun,
there by (A) allowing the user in hot weather to expand dark, colored, ventilated tarp in upward position away from sun, to produce cooler temperatures, or allowing user in cold weather to expand magnifying, Plexiglas ventilated tarp to produce warmer temperatures.
